(19) United States
(12) Patent Application Publication
(10) Pub. No.: US 2016/0277482 A1
(43) Pub. Date: Sep. 22, 2016

(54) Method and Apparatus for Collaborative Drawing

(71) Applicant: Janet Brumbaugh, Felton, CA (US)

(72) Inventor: Janet Brumbaugh, Felton, CA (US)

(21) Appl. No.: 14/659,248

(22) Filed: Mar. 16, 2015

(51) Int. Cl. H04L 29/08; G06F 3/0488; G06F 3/0484

(52) U.S. Cl. CPC H04L 67/10; G06F 3/0484; G06F 3/0488

(57) ABSTRACT

Intended for two or more users with individual graphic devices. When one user draws on a device, information for that element is sent to other device(s). The other device(s) receive the element in real time where it is integrated into whatever graphic design is already extant. Only information needed to recreate the element is sent, not the entire graphic design. Thus, an entire image is neither uploaded nor downloaded each time a user creates an element.

### CROSS-REFERENCE TO RELATED APPLICATION

This application claims the priority benefit of U.S. Provisional Application No. 61/953,890 filed on Mar. 16, 2014 and entitled “Method and Apparatus for Collaborative Drawing”, which is hereby incorporated herein by reference in its entirety.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### REFERENCE TO COMPUTER PROGRAM LISTING APPENDIX

This application includes a computer program listing appendix submitted electronically.

### FIELD OF THE INVENTION

Broadly stated, disclosed in some embodiments is a method and apparatus for sending elements of a drawing between connected devices without sending an entire image.

### SUMMARY OF THE INVENTION

In one embodiment of the invention, an application, commonly referred to as an “app,” is described. The app preferably runs on a mobile device, such as a mobile (cellular) telephone, a tablet device, a notebook computer, or a laptop computer. However, it will perform equally well on a general purpose desktop computer. The purpose of the app is to permit a user to draw on a screen. As the user draws, the app breaks down the images into graphic components.

Each component is represented as a JSON (or equivalent) data structure and sent to a drawing server immediately after the user draws the component on the screen. The drawing server may use a cloud messaging push notification function, such as GOOGLE CLOUD MESSAGING FOR ANDROID™ (GCM™) service, to send JSON data to registered devices. Devices that receive the JSON data process the data to recreate the original graphic component. The app allows for the quick transfer of graphic information. It eliminates the need to upload an entire image each time a user makes a change and at the same time eliminates the need to download the entire image to each receiving device. The app permits a “one to many” that a drawer may send drawing changes from a single device to any number of receiving devices.

Aspects of this specification, comprising routines and data structures, in addition to contributing to the operation of the app, are relevant to other types of apps. One embodiment of the invention, included in Appendix A, comprises computer code in the Java language.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a high level diagram of an apparatus implementing the invention according to one embodiment.

FIG. 2 is a high level diagram of a method implementing the invention according to one embodiment.

FIG. 3 is a diagram of steps in the initialization phase of the method according to one embodiment.

FIG. 4 is a diagram of steps in the registration phase of the method according to one embodiment.

FIG. 5 is a diagram of steps showing the starting of the user interface according to one embodiment.

FIG. 6 is a diagram of steps in the drawing receiving phase according to one embodiment.

FIG. 7 is a diagram of steps in the user drawing creation and sending phase according to one embodiment.

FIG. 8 is a diagram of the background un-initialization according to one embodiment.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

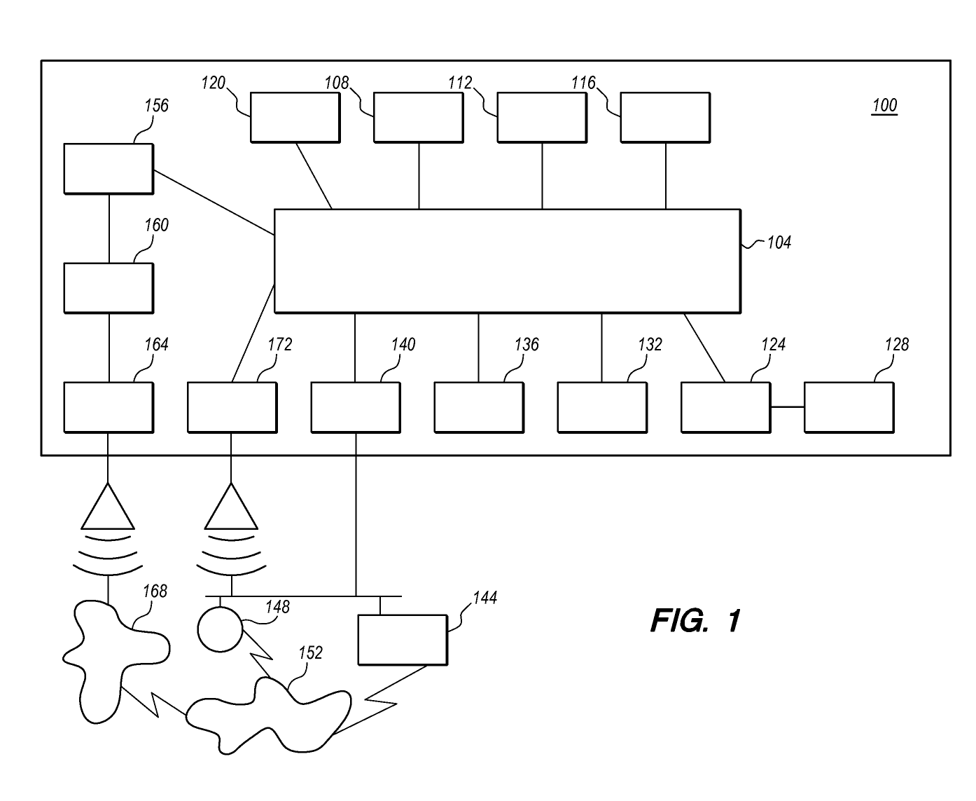

Referring initially to FIG. 1, a system is shown which includes a digital processing apparatus 100. This system is preferably a mobile device (such as a cellular telephone, notebook computer, tablet computer, or laptop computer). However, the app will perform equally well on other types of general purpose computers such as desktop computers. Digital processing apparatus 100 comprises an operating system (not shown).

The example apparatus in FIG. 1 includes provision for input power 112 (such as a battery and power management IC), one or more application processor(s) 104, RAM memory 136, and internal memory 132 (e.g., non-volatile memory such as flash memory, hard drive, CD-ROM drive, or DVD drive). Communications may be provided by optional network adapter 140, and/or optional Wi-FI adapter 172, to a local area network 148 or to a point-to-point network 144. Either or both local area network 148 and point-to-point network 144 may be connected to a wide area network (network cloud) 152. In addition, optional connectivity to cellular network 168 may be provided via baseband processor 156 (a CPU that manages cellular network 168 communications), transceiver 160 which handles the broadcast and reception of radio signals with network or subscriber equipment, and one or more power amplifiers 164 which increase signal power up to levels required for wireless communication. Optionally, cellular network 168 may be connected to network cloud 152.

Electronic visual display 124 typically comprises a touch screen in the case of a cellular phone or a late model personal computer, and preferably supports graphics. Data input may be through one or more of the following agencies: keyboard 120 (soft or hard), touch interface or pointing device 116, voice (not shown), disk storage (optionally comprising internal memory 132), local area network 148, point-to-point network 144, and cellular network 168.

One or more features of the computer as shown may be omitted while still permitting the practice of the invention. For example, apparatus pointing device 116, such as a mouse, or printer 108 is not required where the apparatus 100 is a cellular telephone. Either in place of, or in conjunction with, the touch screen may be a writing device 128.

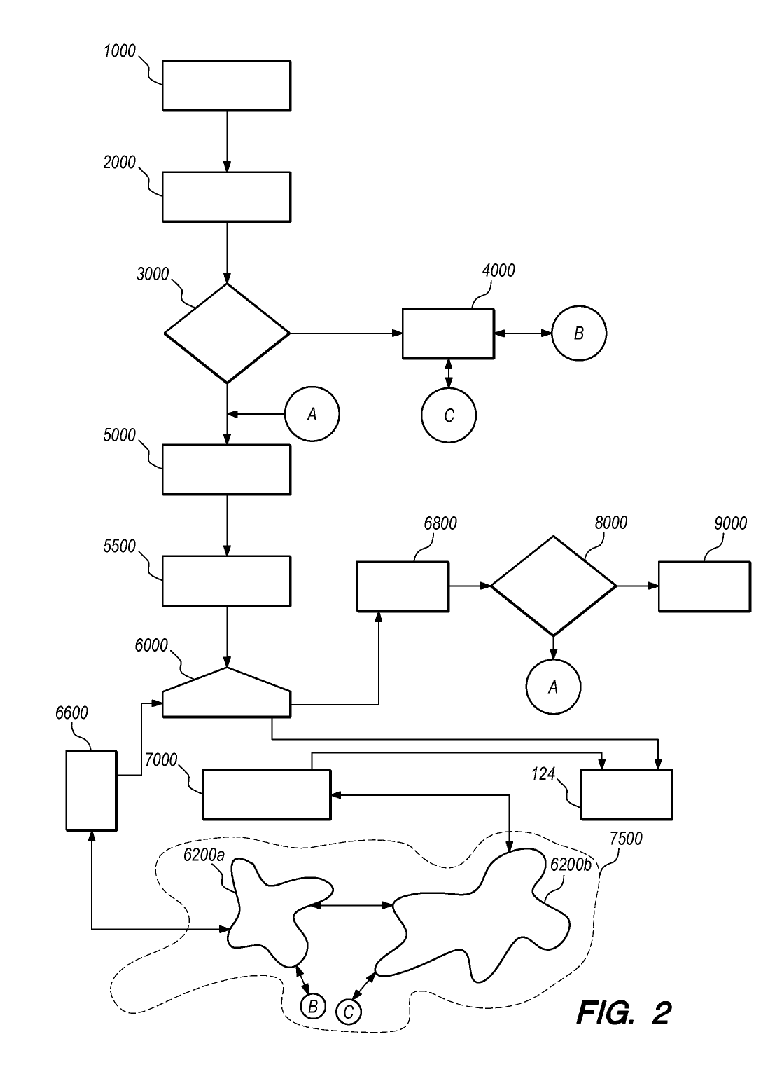

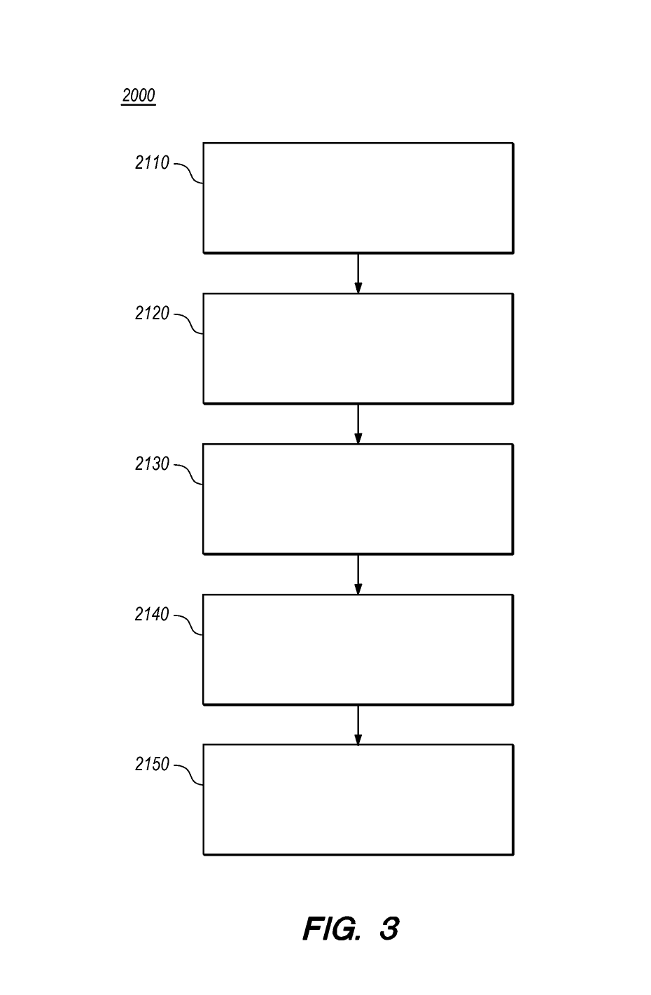

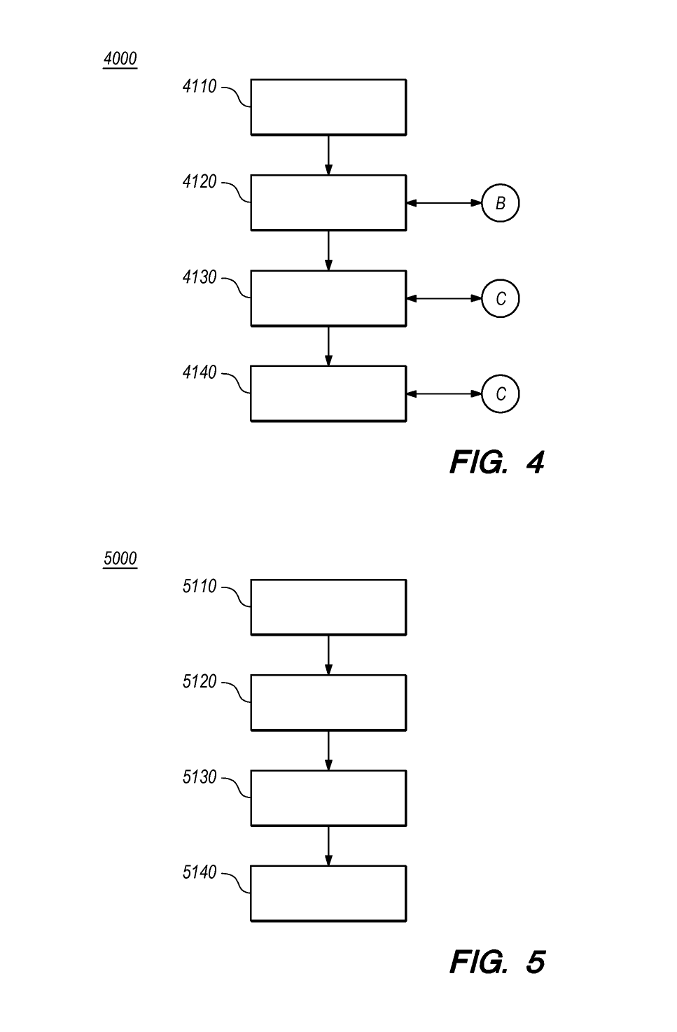

FIG. 2 is a high level diagram of a method implementing the invention according to one embodiment. The app begins at start step 1000. Then various parameters and processes are initialized at step 2000 (shown in more detail in FIG. 3 and discussed in detail in an accompanying description). At step 3000, a determination is made whether the app is registered with the cloud messaging push notification service (e.g. GCM™ service) (herein referred to as cmpns). If the app is not registered, then a request is made to the cmpns to create a new registration at step 4000 (shown in more detail in FIG. 4 and discussed in detail in an accompanying description). Then the method proceeds to step 5000. At step 5000 (shown in more detail in FIG. 5 and discussed in detail in an accompanying description), the app user function begins.

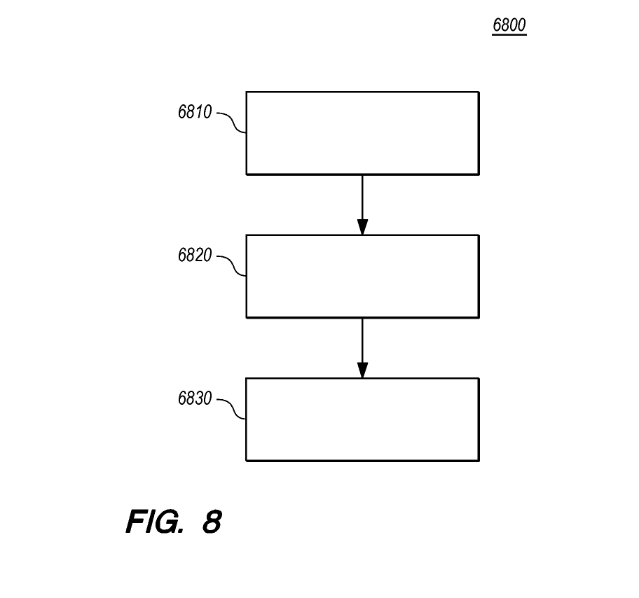

Proceeding to step 5500, a drawer function begins. Step 6000 is a decider which runs asynchronously. The decider at step 6000 is looking for one of two events; whether a drawing element is being received or whether there needs to be a background un-initialization. In the event that an element is received from step 6600, the decider 6000 proceeds to draw the element on display 134. In the event that there need to be a background un-initialization, decider 6000 proceeds to step 6800, a background un-initialization process (shown in more detail in FIG. 8 and discussed in detail in an accompanying description). The background un-initialization process 6800 proceeds to an app lifecycle determination step 8000 which either decides to continue the app at step 5000 or stops the app at step 9000.

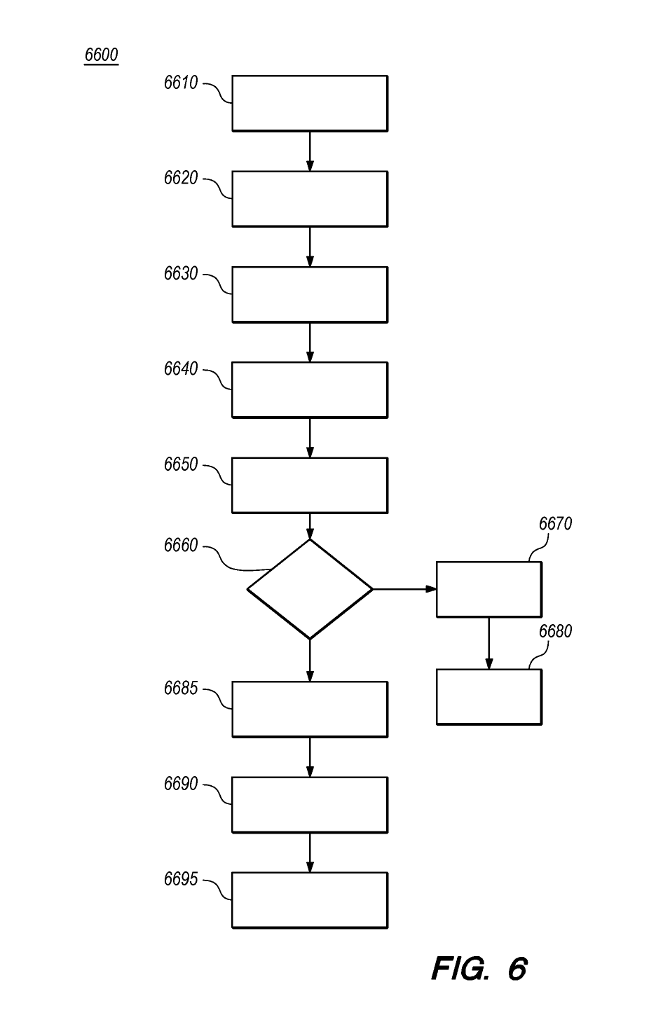

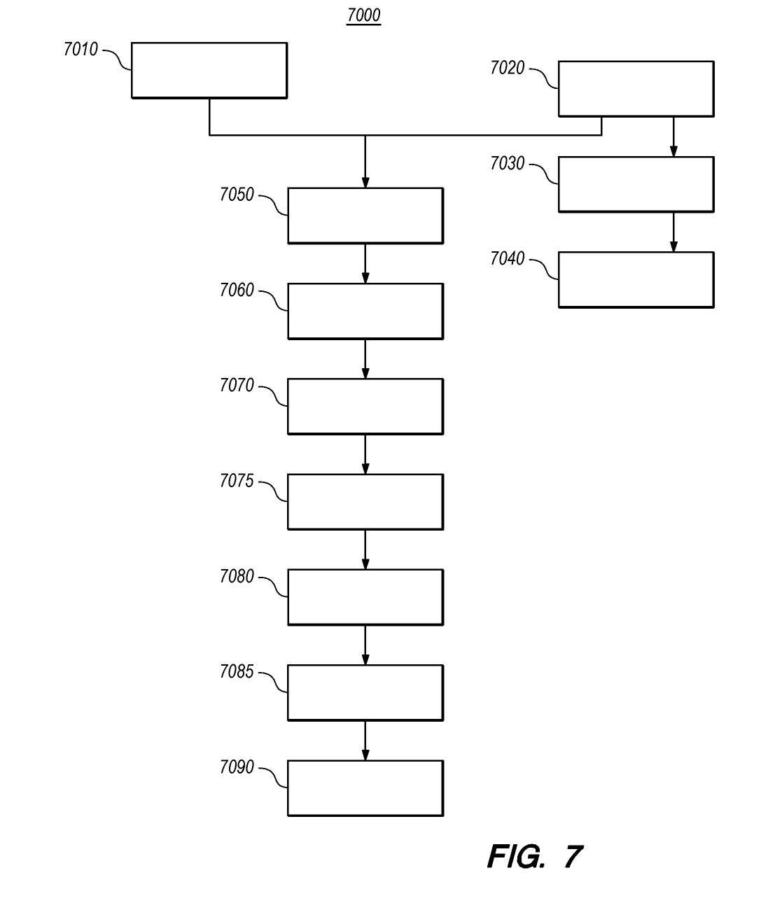

Element receiver 6600, which runs asynchronously, is in communication with server 6200a while element sender 7000, which also runs asynchronously, is in communication with server 6200b. Element receiver 6600 receives JSON (or equivalent) data (from server 6200a), parses it, and sends it to decider 6000 which in turn draws the received element on display 124. Element receiver 6600 is shown in more detail in FIG. 6 and discussed in detail in an accompanying description. Element sender 7000 receives element data from a drawer (not shown), turns the data into JSON (or equivalent) data which is then sent to server 6200b. Element sender 7000 is shown in more detail in FIG. 7 and discussed in detail in an accompanying description.

Server 6200a is in communication with server 6200b and both servers 6200a and 6200b may be part of an encompassing wide area network 7500 such as the internet. It will be appreciated by someone skilled in the art that the depiction of servers 6200a and 6200b and the network 7500 is for conceptional purposes. In an actual implementation, servers 6200a and 6200b may be the same server or spread out among multiple servers. And any number of multiple paths between servers 6200a and 6200b among multiple servers within network 7500 is not only possible but likely.

FIG. 3 shows the sub-steps for the initialization process step 2000. At step 2110, a network class/object is initialized. Then at step 2120, a main graphics renderer is initialized. At step 2130, a main renderer's element queue is initialized using the graphics renderer from step 2120. An element is defined as one of a list of things to draw such as a line, a square, a triangle, a complex picture, a bitmap graphic, etc. That is, an element is virtually anything that can be shown graphically. At step 2140 at least one graphic framework is initialized. There are several graphic frameworks known in the art such as the OPENGL™ framework or the SURFACEVIEW™ framework. Other equivalent frameworks that are now known or will become known in the future may also be substituted. Next, step 2150 initializes each type of element graphic renderer.

FIG. 4 shows sub-steps of step 4000 in the registration phase of the method according to one embodiment. Step 4110 requests a new cmpns registration identification for the current app. Proceeding to step 4120, the registration identification is fetched from server 6200a. Then step 4130 sends the registration identification to server 6200b. Next, step 4140 stores the registration identification in a datastore, such as RAM memory 136, and/or internal memory 132.

FIG. 5 shows the sub-steps of step 5000 relating to the starting of the user interface according to one embodiment. Step 5110 brings the app to the foreground. Then step 5120 registers the cmpns broadcast/receiver. Step 5130 creates a listener. And step 5140 sets the graphics render mode to render continuously. In an embodiment in which OpenGL graphics framework is not being used, step 5140 is omitted. At this point it should be clear that the method is fundamentally asynchronous; events can occur independently of the main program flow. Thus, while the drawings show a system flow, it is to be understood that the order is not rigid and events may occur out of order.

FIG. 6 shows the sub-steps of element receiver 6600. At step 6610, the app receives a push notification from the cmpns. Then the app receives the push notification at step 6620. The app, at step 6630, issues a broadcast message containing the notification data. The app broadcast receiver receives the message at step 6640. Then the app broadcast receiver parses JSON (described and discussed below) and converts it into an element at step 6650. Step 6660 determines if the element is an image element. If the element is an image element, it is downloaded from the image server at step 6670 and step 6680 stores a file containing the image on the server 6200b file system.

Regardless of whether the element is an image or not, step 6660 proceeds to step 6685 where the element is added to a renderer queue. At step 6690, a renderer iterates through the queue each time a frame is to be drawn. And step 6695 draws each element in the queue on display 124 using a type of renderer specific to the type of element to be drawn.

FIG. 7 shows sub-steps associated with element sender 7000. Either the user draws a new element at step 7010 or the user loads a new image at step 7020 such as a photograph. If the user has loaded a new image, then step 7030 uploads bitmap data of the image to the server 6200b where, at step 7040, a server process stores the bitmap data in a file. Both step 7010 and 7020 proceed to step 7050 which stores the item or image characteristics in an element object. Then step 7060 converts the element object to formatted JSON. Step 7070 uploads the formatted JSON to the server 6200b along with headers containing the identification of the device 100 and the identifications of each device intended to receive the data. Server 6200b reads posted data from an input stream at step 7075. Next, step 7080 obtains identifications from headers of the data. Step 7085 sends the data to cmpns along with the identifications of destination devices. Step 7090 does a push notification containing the JSON to each of the destination devices.

As mentioned above, the app is primarily asynchronous. In particular, the background un-initiator 6800, (FIG. 8) may be invoked at any point in the execution of the app. Sub-steps of step 6800 include, among others, step 6810 which sends the app to the background. Then step 6820 unregisters the cmpns broadcast/receiver (i.e., the “listener”). Step 6830 determines if the graphics render mode is “dirty.” That is, step 6830 sets graphics render mode to render only if dirty. In another embodiment, where OpenGL graphics framework is not used in the application, step 6830 is omitted.

### Data Structures

Each type of graphical item (such as a stroke) is defined as an element in the code. For example, a stroke item is a line that connects a series of points. The Stroke class stores the information about the stroke, such as the points and color.

Every type of item also has a corresponding graphics renderer class that uses the element information to draw it on the screen using, for example, OpenGL. For example, the Stroke class uses the StrokeRenderer class.

The principals of Object Oriented Design and Runtime Polymorphism are used to define and render the elements using the appropriate classes at runtime.

The base Element class defines an identification, and a render method. Each type of element extends from this base class and overrides the render method. For example, the Stroke class extends from the base Element class and overrides the render( )method to draw a stroke on the screen. The Texture class overrides the base Element class and overrides the render( )method so that a image such as a photo can be drawn to the screen.

Elements are converted to formatted JSON when they are created. The JSON data is uploaded to the drawing server (e.g. 6200b), and then to push notifications, where they are ‘pushed’ to the other devices.

### Element Definitions

The architecture and concept is meant to be extensible, meaning that elements in addition to those currently in use may be defined in the future. Elements can, by way of example, include shapes such as squares, triangles and circles, or arrows and ‘template’ shapes such as a house, animal or person. Different elements can be used by different types of targeted industries such as business, or teaching.

### Stroke Element

A stroke is a list of points. Each point is a pixel location on the screen. The stroke renderer will draw a line between each point.
It contains the following information:
Element id: A unique identifier for this particular element
Element type: A numeric type, that identifies what type of element this is. For example, a 0 could mean that this a stroke element
red, green, blue, alpha: RGB color components. Together they define what color and the alpha transparency of the stroke.
width: The width in pixels for this stroke
points: The list of points for this stroke. The renderer will draw a line between each point.
JSON format with example values:

| { | |
|---|---|
| “elementId” | : 0, |
| “elementType: | : 0, |

| | |
|---|---|
| “strokeId” | : 0, |
| “red” | : 255.0 |
| “green” | : 0.0 |

| | |
|---|---|
| “blue” | :0.0 |

| | |
|---|---|
| “alpha” | : 1.0 |
| “width” | : 5 |
| “points” | “ [{“x”:0,“y”:0}, {“x”:0,“y”:0] |

}

### Texture Element

A texture element defines how a bitmap is drawn to the screen. The texture renderer will draw an image such as a photo on the screen.
It contains the following information:
Element id: A unique identifier for this particular element
Element type: A numeric type, that identifies what type of element this is. For example, the value 1 could mean that this a texture element.
Texture id: An id used to render the texture as a bitmap
Size: The size of the bitmap in bytes on the filesystem
Filename: The name of the bitmap file.
JSON format with example values:

{

| | |
|---|---|
| “elementId” | : 0, |

| | |
|---|---|
| “elementType: | : 1, |

| | |
|---|---|
| “textureId” | : 0, |
| “size” | : 1024 |
| “filename” | : myTexture.png |

}

The specific JSON formats shown here are for example purposes only. Fields may be added or subtracted while maintaining the equivalent functionality.

Those skilled in the art will recognize that the present invention has been described in terms of exemplary embodiments based upon use of a programmed processor (e.g., digital processing apparatus 100). However, the invention should not be so limited, since the present invention could be implemented using hardware component equivalents such as special purpose hardware and/or dedicated processors that are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention. Moreover, although the present invention has been described in terms of a general purpose personal computer executing a method, the method can be carried on a dedicated machine without departing from the present invention. Conversely, the present system has been described in terms of a state machine and such state machine can be implemented as either a hardware or software based state machine. Moreover, those skilled in the art will understand that the exact configuration, order of steps, and other details described in connection with the above exemplary embodiment should not be considered limiting, but are presented by way of illustration.

Those skilled in the art will appreciate that the program steps and associated data used to implement the embodiments described above can be implemented using disc storage as well as other forms of storage such as for example Read Only Memory (ROM) devices, Random Access Memory (RAM) devices; optical storage elements, magnetic storage elements, magneto-optical storage elements, flash memory, core memory and/or other equivalent storage technologies without departing from the present invention. Such alternative storage devices should be considered equivalents.

The present invention, as described in embodiments herein, is implemented using a programmed processor executing programming instructions that are broadly described above. The instructions can be stored on any suitable electronic storage medium or transmitted over any suitable electronic communication medium or otherwise be present in any computer readable or propagation medium. However, those skilled in the art will appreciate that the processes described above can be implemented in any number of variations and in many suitable programming languages without departing from the present invention. For example, the order of certain operations carried out can often be varied, additional operations can be added or operations can be deleted without departing from the invention. Error trapping can be added and/or enhanced and variations can be made in user interface and information presentation without departing from the present invention. Such variations are contemplated and considered equivalent.

Software code and/or data embodying certain aspects of the present invention may be present in any computer readable medium, transmission medium, storage medium or propagation medium including, but not limited to, electronic storage devices such as those described above, as well as carrier waves, electronic signals, data structures (e.g., trees, linked lists, tables, packets, frames, etc.) optical signals, propagated signals, broadcast signals, transmission media (e.g., circuit connection, cable, twisted pair, fiber optic cables, waveguides, antennas, etc.) and other media that stores, carries or passes the code and/or data. Such media may either store the software code and/or data or serve to transport the code and/or data from one location to another.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as falling within the scope of the appended claims.

### APPENDIX

The Appendix, submitted electronically, forms a part of the patent application entitled “Method and Apparatus for Collaborative Drawing.”

This Appendix, which is hereby incorporated by reference herein in its entirety, includes computer programming code in the JAVA language. It should be recognized, however, that this code is not meant to limit the scope of the invention, but only to provide details for a specific embodiment.

### REFERENCE TO COMPUTER PROGRAM LISTING APPENDICES

Computer program listing appendix, corresponding to the program listings discussed below, is filed herewith electronically. This computer program listing appendix is incorporated herein by reference in its entirety, in accordance with 37 C.F.R. 1.77(b)(4).

The files are identified as follows:

| Date | Time | Size | File Name |
|---|---|---|---|
| 12/18/2012 | 10:31 AM | 3,448 | AlphaPatternDrawable.java |
| 02/26/2013 | 12:03 PM | 2,261 | AppConstants.java |
| 12/18/2012 | 12:02 PM | 4,119 | ColorPanelView.java |
| 12/18/2012 | 03:53 PM | 3,144 | ColorPickerDialog.java |
| 12/18/2012 | 12:02 PM | 21,519 | ColorPickerView.java |
| 02/19/2013 | 02:34 PM | 2,168 | CommonUtilities.java |
| 02/22/2013 | 03:06 PM | 347 | Element.java |
| 02/28/2013 | 10:42 AM | 19,228 | ElementDao.java |
| 02/06/2013 | 08:12 PM | 1,885 | ElementService.java |
| 02/27/2013 | 12:12 PM | 4,199 | GCMIntentService.java |
| 02/01/2013 | 11:51 AM | 230 | GLProgram.java |
| 02/01/2013 | 10:44 AM | 121 | GLProgramBase.java |
| 02/01/2013 | 11:15 AM | 183 | GLProgramTexture.java |
| 03/01/2013 | 02:12 PM | 21,009 | ImageUtils.java |
| 02/17/2014 | 09:36 AM | 5,184 | JsonUtils.java |
| 02/17/2014 | 09:28 AM | 2,615 | LDApplication.java |
| 02/17/2014 | 09:27 AM | 11,621 | LDGL20Renderer.java |
| 02/17/2014 | 09:27 AM | 6,932 | LDGLSurfaceView.java |
| 12/27/2012 | 04:34 PM | 4,488 | LynxDrawImageView.java |
| 02/17/2014 | 09:31 AM | 22,243 | MainActivity.java |
| 02/26/2013 | 08:52 PM | 12,639 | Network.java |
| 12/27/2012 | 03:47 PM | 877 | RawResourceReader.java |
| 03/01/2013 | 10:54 AM | 188 | RelativePoint.java |
| 02/19/2013 | 12:05 PM | 7,141 | ServerUtilities.java |
| 12/27/2012 | 03:47 PM | 2,861 | ShaderHelper.java |
| 12/27/2012 | 03:47 PM | 2,589 | ShapeBuilder.java |
| 03/01/2013 | 12:08 PM | 5,365 | Stroke.java |
| 02/28/2013 | 12:53 PM | 4,274 | StrokeRenderer.java |
| 01/31/2013 | 03:01 PM | 442 | Text.java |
| 12/18/2012 | 04:20 PM | 1,538 | TextDialog.java |
| 01/31/2013 | 02:58 PM | 2,215 | TextRenderer.java |
| 02/28/2013 | 01:10 PM | 8,435 | Texture.java |
| 12/27/2012 | 03:47 PM | 1,361 | TextureHelper.java |
| 02/28/2013 | 01:11 PM | 2,727 | TextureRenderer.java |

I claim:

1. A digital processing apparatus comprising:
an operating system; and
an application, in communication with the operating system, comprising an element sender 7000 that receives element data and turns the element data into one or more data objects comprising attribute-value pairs which the element sender sends to a server 6200b wherein:
the element sender 7000 stores element characteristics in an element object;
the element sender 7000 converts the element object to one or more formatted objects of the one or more data objects;
the element sender 7000 sends the formatted objects to server 6200b along with headers containing an identification of device 100.

2. The apparatus of claim 1 wherein the one or more data objects are JSON data.

3. The apparatus of claim 1 wherein the element data is an image and wherein the application uploads bitmap data of the image to the server 6200b.

4. The apparatus of claim 1 wherein the application uploads identifications of one or more receiver devices to the server 6200b.

5. The apparatus of claim 1 wherein the application performs an initialization wherein the initialization comprises:
a network class/object initialization;
a main graphics renderer initialization;
a main renderer element queue initialization using the graphics renderer;
a graphic framework initialization; and
initialization of each type of element graphic renderer.

6. The apparatus of claim 5 wherein the application performs a registration wherein the registration comprises:
the application requests a cmpns registration identification; and
the application sends the registration identification to the server 6200b.

7. The apparatus of claim 6 wherein the user interface is started and wherein:
the application is brought to the foreground;
the application registers a cmpns broadcast/receiver; and
the application creates a listener;

8. The apparatus of claim 7 wherein the application sets the graphics renderer to render continuously.

9. A digital processing apparatus implemented method comprising:
an operating system; and
an application, communicating with the operating system, comprising an element sender 7000 that receives element data and turns the element data into one or more data objects comprising attribute-value pairs which the element sender sends to a server 6200b and further comprising:
storing by the element sender 7000 element characteristics in an element object;
converting by the element sender 7000 the element object to one or more formatted objects of the one or more data objects;
sending by the element sender 7000 the formatted objects to server 6200b along with headers containing an identification of device 100.

10. The method of claim 9 wherein the one or more data objects are JSON data.

11. The method of claim 9 wherein the element data is an image and wherein the application uploads bitmap data of the image to the server 6200b.

12. The method of claim 9 wherein the application uploads identifications of one or more receiver devices to the server 6200b.

13. The method of claim 9 wherein the application performs an initialization wherein the initialization comprises:
initializing a network class/object;
initializing a main graphics renderer;
initializing a main renderer element queue using the graphics renderer;
initializing a graphic framework; and
initializing each type of element graphic renderer.

14. The method of claim 13 wherein the application performs a registration wherein the registration comprises:
requesting a cmpns registration identification; and
sending the registration identification to the server 6200b.

15. The method of claim 14 wherein the user interface is started and further comprising:
bringing the application to the foreground;
registering a cmpns broadcast/receiver; and
creating a listener;

16. The method of claim 15 wherein the application sets the graphics renderer to render continuously.
